(19) United States
(12) Patent Application Publication
(10) Pub. No.: US 2017/0160810 A1
(43) Pub. Date: Jun. 8, 2017

(54) METHOD AND DEVICE FOR CONTROLLING OPERATION COMPONENT BASED ON GESTURE

(71) Applicants: Le Holdings (Beijing) Co., Ltd., Beijing (CN); LE SHI ZHI XIN ELECTRONIC TECHNOLOGY (TIANJIN) LIMITED, Beijing (CN)

(72) Inventor: Duan XU, Beijing (CN)

(21) Appl. No.: 15/247,711

(22) Filed: Aug. 25, 2016

Related U.S. Application Data
(63) Continuation of application No. PCT/CN2016/088482, filed on Jul. 4, 2016.

(30) Foreign Application Priority Data
Dec. 8, 2015 (CN) 201510897578.6

(51) Int. Cl. G06F 3/01; G06K 9/00; G06F 3/0481

(52) U.S. Cl. CPC G06F 3/017; G06F 3/04817; G06K 9/00335

(57) ABSTRACT

The present disclosure relates to methods and apparatus for controlling an operation component based on a gesture, as well as computer programs, computer readable media, and devices regarding same. An illustrative method may include detecting first position coordinates of an icon corresponding to motion sensing in a current interface; when spatial gesture information of a human body gesture for triggering an operation component in the current interface is detected, analyzing the spatial gesture information to determine the operation component corresponding to the spatial gesture information and second position coordinates of the operation component in the current interface; when the first position coordinates have an intersection with the second position coordinates, setting the icon corresponding to motion sensing to an overlay state. In accordance with such features, implementations herein may solve drawbacks in existing solutions where a click event cannot be transferred to a correct operation component.

### CROSS-REFERENCE TO RELATED APPLICATIONS

This application is a continuation of International PCT patent application No. PCT/CN2016/088482, having international filing date of Jul. 4, 2016 (attached hereto as an Appendix), and claims benefit/priority to Chinese Patent Application No. 201510897578.6, filed on Dec. 8, 2015, all of which are incorporated herein by reference in entirety.

### BACKGROUND

Technical Field

The present disclosure relates to the technical field of interface design, in particular to a method and apparatus for controlling an operation component based on a gesture, a computer program, a storage medium and a device.

Description of Related Information

Motion sensing refers to controlling and operating software by body actions of a user. The motion sensing technology enables people to interact with surrounding devices or environments directly using body actions and to be in immersive interaction with contents without any complex control equipment. At present, the space-based motion sensing technology is already applied to the field of operation and control of interactive network TVs.

However, the inventor has found in the process of implementing the present disclosure that the prior art has at least the following problem:

in the existing network smart TV technology, motion sensing gestures are used to realize clicks in a display interface and click events of corresponding positions are sent; however, a hand icon View of motion sensing will obstruct part of the sent events while moving, and these events may respond on the icon to be obstructed by the hand icon, thereby leading to that the click events cannot be transferred to correct components to produce due effects. It further results in an extremely low accuracy rate of click events of a motion sensing user, and it is difficult to click accurately even though actions are standard. As a result, the operation experience of the motion sensing user is affected.

### OVERVIEW OF SOME ASPECTS

The present disclosure relates to provision of methods and apparatus for controlling an operation component based on a gesture, a computer program, a storage medium and a device, which are intended to solve the problem that a click event cannot be transferred to a correct operation component due to obstruction of an icon to the sent click event in the prior art, and to enhance the operation experience of a motion sensing user.

In order to achieve such advantages, embodiments of the present disclosure provide a method and apparatus for controlling an operation component based on a gesture, a computer program, a storage medium and a device.

In one aspect, one embodiment of the present disclosure provides a method for controlling an operation component based on a gesture. The method includes:

detecting first position coordinates of an icon corresponding to motion sensing in a current interface;

when spatial gesture information of a human body gesture for triggering an operation component in the current interface is detected, analyzing the spatial gesture information to determine the operation component corresponding to the spatial gesture information and second position coordinates of the operation component in the current interface;

when the first position coordinates have an intersection with the second position coordinates, setting the icon corresponding to motion sensing to a transparent overlay state.

In another aspect, one embodiment of the present disclosure further provides electronic device for controlling an operation component based on a gesture, comprising:

at least one processors; and

a memory communicably connected with the at least one processor for storing instructions executable by the at least one processor, wherein execution of the instructions by the at least one processor causes the at least one processor to:

detect first position coordinates of an icon corresponding to motion sensing in a current interface;

when spatial gesture information of a human body gesture for triggering an operation component in the current interface is detected, analyze the spatial gesture information to determine the operation component corresponding to the spatial gesture information and second position coordinates of the operation component in the current interface;

when the first position coordinates have an intersection with the second position coordinates, set the icon corresponding to motion sensing to a transparent overlay state.

In another aspect, one embodiment of the present disclosure further provides a non-transitory computer-readable storage medium storing executable instructions that, when executed by an electronic device, cause the electronic device to:

detect first position coordinates of an icon corresponding to motion sensing in a current interface;

when spatial gesture information of a human body gesture for triggering an operation component in the current interface is detected, analyze the spatial gesture information to determine the operation component corresponding to the spatial gesture information and second position coordinates of the operation component in the current interface;

when the first position coordinates have an intersection with the second position coordinates, set the icon corresponding to motion sensing to a transparent overlay state.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow diagram of a method for controlling an operation component based on a gesture provided by one embodiment of the present disclosure.

FIG. 2 is a subdivided flow diagram of step S11 in a method for controlling an operation component based on a gesture provided by another embodiment of the present disclosure.

FIG. 3 is a structure block diagram of an apparatus for controlling an operation component based on a gesture provided by one embodiment of the present disclosure.

FIG. 4 is a structure block diagram of a detecting unit in an apparatus for controlling an operation component based on a gesture provided by another embodiment of the present disclosure.

### DETAILED DESCRIPTION OF ILLUSTRATIVE IMPLEMENTATIONS

In order to make the aims, technical solutions and advantages of the embodiments of the present disclosure more clear, the technical solutions in the embodiments of the present disclosure will be described below clearly and completely in conjunction with the accompanying drawings in the embodiments of the present disclosure. Apparently, the described embodiments are part, but not all, of the embodiments of the present disclosure. All of other embodiments, obtained by a person of ordinary skill in the art based on the embodiments in the present disclosure without any creative effort, should fall into the protection scope of the present disclosure.

FIG. 1 shows the flow diagram of the method for controlling the operation component based on the gesture provided by one embodiment of the present disclosure.

By referring to FIG. 1, the method for controlling the operation component based on the gesture provided by the embodiment of the present disclosure specifically include the following steps:

S11, first position coordinates of an icon corresponding to motion sensing in a current interface are detected.

Specifically, the icon corresponding to motion sensing is a View, which may obstruct part of sent events when moving. These events may respond on the icon to be obstructed by the icon; therefore, this part of events cannot be transferred to correct operation components to produce due trigger effects. For this reason, in the technical solution of the present disclosure, the position coordinates of the icon corresponding to motion sensing in the current display interface are detected and regarded as the first position coordinates, and further compared with the position coordinates of an operation component corresponding to a trigger event to determine whether the icon corresponding to motion sensing obstructs the trigger to the operation component.

In this embodiment, the icon corresponding to motion sensing is similar to a hand icon in a display interface of a smart TV.

S12, when spatial gesture information of a human body gesture for triggering an operation component in the current interface is detected, the spatial gesture information is analyzed to determine the operation component corresponding to the spatial gesture information and second position coordinates of the operation component in the current interface.

Specifically, in this embodiment, a preset motion sensing device is detected; after the motion sensing device senses the spatial gesture information of a human body gesture, a detection is performed on whether there is the spatial gesture information of a human body gesture for triggering an operation component in the current interface; if the spatial gesture information of the human body gesture for triggering the operation component in the current interface is detected, the spatial gesture information is analyzed to determine the operation component corresponding to the spatial gesture information and the second position coordinates of the operation component in the current interface.

Wherein, the spatial gesture information of the human body gesture for triggering the operation component in the current interface in this embodiment specifically includes azimuth information, posture information and position information that correspond to the current human body gesture.

Accordingly, the motion sensing device includes a compass, a gyroscope, a wireless signal module and at least one sensor, which are used to detect azimuth information, posture information and position information that correspond to a human body gesture. The sensor includes one or more of an acceleration sensor, a direction sensor, a magnetic sensor, a gravity sensor, a rotating vector sensor and a linear acceleration sensor.

It needs to be noted that the azimuth information and the posture information corresponding to a human body gesture may include three-dimensional displacements of the hand in space, including a front-and-back displacement, an up-and-down displacement, a left-and-right displacement, a combination of these displacements or the like.

S13, when the first position coordinates have an intersection with the second position coordinates, the icon corresponding to motion sensing is set to a transparent overlay state.

Specifically, in this step, the first position coordinates, detected in step S11, of the icon corresponding to motion sensing in the current interface are compared with the second position coordinates, detected in step S12, of the operation component corresponding to the spatial gesture information of the human body gesture for triggering the operation component in the current interface to determine whether the icon corresponding to motion sensing may obstruct the trigger to the operation component. When the first position coordinates have an intersection with the second position coordinates, i.e., when the icon corresponding to motion sensing may obstruct the trigger to the operation component, the icon corresponding to motion sensing is set to the transparent overlay state.

In this embodiment of the present disclosure, when the icon corresponding to motion sensing may obstruct the trigger to the operation component, the icon corresponding to motion sensing is set to the transparent overlay state so as to transmit, rather than obstruct, the trigger event to the current operation component. That is, the hand icon does not affect receiving of the trigger event any more, and the operation component at the lower layer is capable of directly receiving the relevant trigger event to form the correct click event. Therefore, the accuracy rate and the success rate of the trigger are greatly increased, and the operation experience of a motion sensing user is effectively enhanced.

It needs to be noted that the method for controlling the operation component based on the gesture provided by this embodiment is applicable to various mobile devices or smart TVs having display interfaces, which is not specifically limited in the present disclosure.

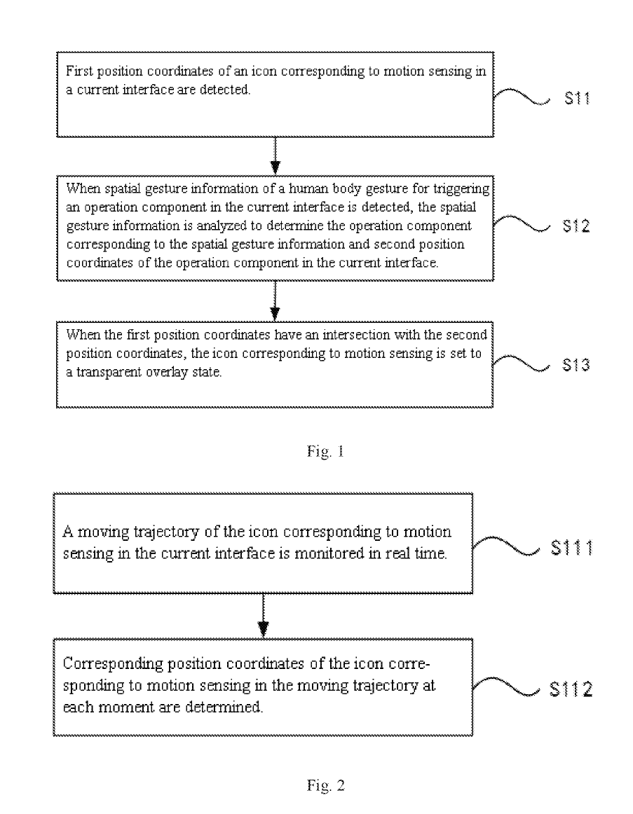

Further, as show in FIG. 2, in another embodiment of the present disclosure, step S11 specifically includes the following steps:

S111, a moving trajectory of the icon corresponding to motion sensing in the current interface is monitored in real time.

S112, corresponding position coordinates of the icon corresponding to motion sensing in the moving trajectory at each moment are determined.

Specifically, the icon corresponding to motion sensing may move correspondingly along with the change of the human body gestures. In this embodiment, the position coordinates of the icon corresponding to motion sensing in the moving trajectory at each moment are determined by monitoring in real time the moving trajectory of the icon corresponding to motion sensing in the current interface, and then the first position coordinates of the icon corresponding to motion sensing in the current display interface at different moments can be obtained accurately so as to accurately determine whether the icon corresponding to motion sensing may obstruct trigger events to operation components.

Further, in step S12 of this embodiment, the operation of analyzing the spatial gesture information to determine the operation component corresponding to the spatial gesture information and the second position coordinates of the operation component in the current interface specifically includes the following steps:

parsing the spatial gesture information to obtain azimuth information, posture information and position information corresponding to the current human body gesture;

determining a trigger event corresponding to the spatial gesture information according to the azimuth information and the posture information;

determining an operation component corresponding to the trigger event and the second position coordinates of the operation component in the current interface according to the position information.

Wherein, the operation of determining the trigger event corresponding to the spatial gesture information according to the posture information further includes the following steps:

judging whether the posture information is composed of two postures of push-forward and pull-backward;

when the posture information is composed of the two postures of push-forward and pull-backward, determining the trigger event corresponding to the spatial gesture information as a click event.

Wherein, the trigger event refers to an event generated when a user performs an operation, for example, an event generated when the user clicks a mouse button.

In this embodiment, three-dimension parsing is performed on multi-spatial gesture information to obtain the azimuth information, the posture information and the position information corresponding to the current human body gesture. First, the trigger event corresponding to the spatial gesture information is determined according to the azimuth information and the posture information. Second, the operation component corresponding to the trigger event and the second position coordinates of the operation component in the current display interface are determined according to the position information.

Wherein, the trigger event corresponding to the spatial gesture information specifically refers to the click event.

It needs to be noted that the click event is composed of two gestures of push-forward and pull-backward. Upon the push-forward trigger, a down event of a corresponding point is sent; upon the pull-backward trigger, an up event of a corresponding point is sent. The down and up events are combined to form the click event.

In this embodiment of the present disclosure, a further judgment is made on whether the posture information is composed of two postures of push-forward and pull-backward to determine whether the trigger event corresponding to the spatial gesture information is the click event. When the posture information is composed of the two postures of push-forward and pull-backward, the trigger event corresponding to the spatial gesture information is determined as the click event.

Further, before detecting the first position coordinates of the icon corresponding to motion sensing in the current interface, the method further includes:

detecting attribute information of the icon corresponding to motion sensing;

when the icon corresponding to motion sensing is in a non-overlay state, executing the step of detecting the first position coordinates of the icon corresponding to motion sensing in the current interface.

Specifically, in this embodiment of the present disclosure, before step S11 is executed, it first needs to detect the attribute information of the icon corresponding to motion sensing. If the attribute information of the icon corresponding to motion sensing is a transparent overlay state, no subsequent operation needs to be carried out. If the attribute information of the icon corresponding to motion sensing is a non-transparent overlay state, subsequent steps are carried out continuously to realize setting of the icon corresponding to motion sensing to the transparent overlay state when the icon corresponding to motion sensing may obstruct the trigger to an operation component. As a result, it can be avoided that the motion sensing icon obstructs part of sent events while moving; the accuracy rate and the success rate of the trigger events for motion sensing thus can be increased.

In addition, in regard to the above method embodiment, for the sake of simple description, it is expressed as combinations of a series of actions. However, a person skilled in the art should know that the present disclosure is not limited by the described order of actions. Besides, a person skilled in the art should also know that the embodiments described in the description all are optional embodiments, and the actions and modules involved therein are not necessary for the present disclosure.

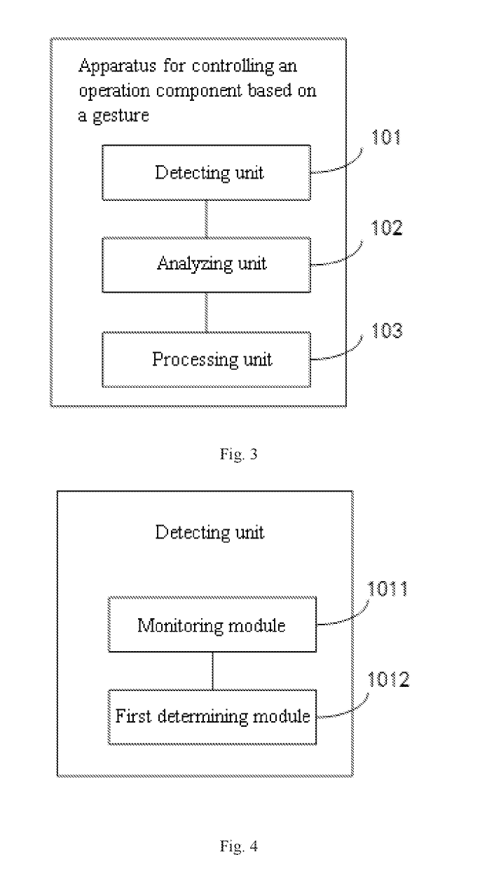

On the basis of the same inventive concept as that of the method, one embodiment of the present disclosure also provides an apparatus for controlling an operation component based on a gesture. FIG. 3 shows the structure block diagram of the apparatus for controlling the operation component based on the gesture provided by the embodiment of the present disclosure.

By referring to FIG. 3, the apparatus for controlling the operation component based on the gesture provided by the embodiment of the present disclosure specifically includes a detecting unit 101, an analyzing unit 102, and a processing unit 103, wherein

the detecting unit 101 is configured to detect first position coordinates of an icon corresponding to motion sensing in a current interface;

the analyzing unit 102 is configured to, when spatial gesture information of a human body gesture for triggering an operation component in the current interface is detected, analyze the spatial gesture information to determine the operation component corresponding to the spatial gesture information and second position coordinates of the operation component in the current interface;

the processing unit 103 is configured to, when the first position coordinates have an intersection with the second position coordinates, set the icon corresponding to motion sensing to a transparent overlay state.

According to this embodiment of the present disclosure, when the icon corresponding to motion sensing may obstruct the trigger to the operation component, the icon corresponding to motion sensing is set to the transparent overlay state so as to transmit, rather than obstruct, the trigger event to the current operation component. That is, the hand icon does not affect receiving of the trigger event any more, and the operation component at the lower layer is capable of directly receiving the relevant trigger event to form the correct click event. Therefore, the accuracy rate and the success rate of the trigger are greatly increased, and the operation experience of a motion sensing user is effectively enhanced.

It needs to be noted that the apparatus for controlling the operation component based on the gesture provided by this embodiment may be various mobile devices or smart TVs having display interfaces, which is not specifically limited in the present disclosure.

Further, the detecting unit 101, as shown in FIG. 4, specifically includes a monitoring module 1011 and a first determining module 1012, wherein

the monitoring module 1011 is configured to monitor in real time a moving trajectory of the icon corresponding to motion sensing in the current interface;

the first determining module 1012 is configured to determine corresponding position coordinates of the icon corresponding to motion sensing in the moving trajectory at each moment.

Further, the analyzing unit 102 specifically includes a parsing module, a second determining module and a third determining module, wherein

the parsing module is configured to parse the spatial gesture information to obtain azimuth information, posture information and position information corresponding to the current human body gesture;

the second determining module is configured to determine a trigger event corresponding to the spatial gesture information according to the azimuth information and the posture information;

the third determining module is configured to determine an operation component corresponding to the trigger event and the second position coordinates of the operation component in the current interface according to the position information.

Still further, the second determining module is specifically configured to judge whether the posture information is composed of two postures of push-forward and pull-backward, and when the posture information is composed of the two postures of push-forward and pull-backward, determine the trigger event corresponding to the spatial gesture information as a click event.

In this embodiment of the present disclosure, the detecting unit 101 is further configured to detect attribute information of the icon corresponding to motion sensing before detecting the first position coordinates of the icon corresponding to motion sensing in the current interface, and when the icon corresponding to motion sensing is in a non-overlay state, execute the operation of detecting the first position coordinates of the icon corresponding to motion sensing in the current interface.

Specifically, in this embodiment of the present disclosure, the detecting unit, before detecting the first position coordinates of the icon corresponding to motion sensing in the current interface, is also required to detect the attribute information of the icon corresponding to motion sensing. If the attribute information of the icon corresponding to motion sensing is a transparent overlay state, no subsequent operation needs to be carried out. If the attribute information of the icon corresponding to motion sensing is a non-transparent overlay state, subsequent operations are carried out continuously to realize setting of the icon corresponding to motion sensing to the transparent overlay state when the icon corresponding to motion sensing may obstruct the trigger event to an operation component. As a result, it can be avoided that the motion sensing icon obstructs part of sent events while moving; the accuracy rate and the success rate of the trigger events for motion sensing thus can be increased, and the experience of a user can be enhanced.

For the apparatus embodiment, it is just simply described as being substantially similar to the method embodiment, and the correlations therebetween just refer to part of the description of the method embodiment.

Another embodiment of the present disclosure further discloses a computer program, including program codes for executing the following operations:

detecting first position coordinates of an icon corresponding to motion sensing in a current interface;

when spatial gesture information of a human body gesture for triggering an operation component in the current interface is detected, analyzing the spatial gesture information to determine the operation component corresponding to the spatial gesture information and second position coordinates of the operation component in the current interface;

when the first position coordinates have an intersection with the second position coordinates, setting the icon corresponding to motion sensing to a transparent overlay state.

Another embodiment of the present disclosure further discloses a storage medium for storing the computer program described above.

An embodiment of the present disclosure also discloses a device, including:

one or more processors;

a memory;

one or more program modules, wherein

the one or more program modules are stored in the memory, and configured to carry out the following operations when executed by the one or more processors:

detecting first position coordinates of an icon corresponding to motion sensing in a current interface;

when spatial gesture information of a human body gesture for triggering an operation component in the current interface is detected, analyzing the spatial gesture information to determine the operation component corresponding to the spatial gesture information and second position coordinates of the operation component in the current interface;

when the first position coordinates have an intersection with the second position coordinates, setting the icon corresponding to motion sensing to a transparent overlay state.

In conclusion, the method and apparatus for controlling the operation component based on the gesture, the computer program, the storage medium and the device provided by the embodiments of the present disclosure have the following advantages: the obstruction of the motion sensing icon to part of sent events while moving is avoided by changing the attribute state of the motion sensing icon, and the problem in the prior art that the click events cannot be transferred to the correct operation components due to the obstruction of the icon to the sent click events is solved. As a result, the accuracy rate and the success rate of the click events of a motion sensing user are greatly increased, and the operation experience of the motion sensing user is effectively enhanced.

The apparatus embodiments described above are merely exemplary, wherein the modules illustrated as separate assemblies may be physically separated or not. The assemblies displayed as units may be physical ones or not, which can be located at the same place or distributed to a plurality of network units. Part or all of the modules may be selected according to actual requirements to achieve the purposes of the solutions of the embodiments. A person of ordinary skill in the art can understand and implement the solutions without any creative effort.

It can be understood by a person of ordinary skill in the art that the implementation of all or part of steps of the above method embodiment can be completed by means of program command related hardware. The aforementioned program can be stored in a computer-readable storage medium. When the program is executed, it executes the steps involved in the above method embodiment. The aforementioned storage medium includes various mediums capable of storing program codes, such as ROM, a RAM, a magnetic disk, an optical disk, and the like.

Finally, it should be noted that the above embodiments are merely intended to illustrate the technical solutions of the embodiments of the present disclosure, rather than limiting them. Although the embodiments of the present disclosure are illustrated in detail with reference to the aforementioned embodiments, a person of ordinary skill in the art should understand that modifications may still be made to the technical solutions recorded in the aforementioned embodiments or equivalent substitutions may be made to part or all of technical features therein; these modifications and substitutions do not cause the nature of the corresponding technical solutions to depart from the scope of the technical solutions in the embodiments of the present disclosure.

1. A method for controlling an operation component based on a gesture, comprising:
detecting first position coordinates of an icon corresponding to motion sensing in a current interface;
when spatial gesture information of a human body gesture for triggering an operation component in the current interface is detected, analyzing the spatial gesture information to determine the operation component corresponding to the spatial gesture information and second position coordinates of the operation component in the current interface;
when the first position coordinates have an intersection with the second position coordinates, setting the icon corresponding to motion sensing to a transparent overlay state.

2. The method according to claim 1, wherein the step of detecting the first position coordinates of the icon corresponding to motion sensing in the current interface comprises:
monitoring in real time a moving trajectory of the icon corresponding to motion sensing in the current interface;
determining corresponding position coordinates of the icon corresponding to motion sensing in the moving trajectory at each moment.

3. The method according to claim 1, wherein the step of analyzing the spatial gesture information to determine the operation component corresponding to the spatial gesture information and the second position coordinates of the operation component in the current interface specifically comprises:
parsing the spatial gesture information to obtain azimuth information, posture information and position information corresponding to the current human body gesture;
determining a trigger event corresponding to the spatial gesture information according to the azimuth information and the posture information;
determining an operation component corresponding to the trigger event and the second position coordinates of the operation component in the current interface according to the position information.

4. The method according to claim 3, wherein the step of determining the trigger event corresponding to the spatial gesture information according to the posture information comprises:
judging whether the posture information is composed of two postures of push-forward and pull-backward;
when the posture information is composed of the two postures of push-forward and pull-backward, determining the trigger event corresponding to the spatial gesture information as a click event.

5. The method according to claim 1, before detecting the first position coordinates of the icon corresponding to motion sensing in the current interface, further comprising:
detecting attribute information of the icon corresponding to motion sensing;
when the icon corresponding to motion sensing is in a non-overlay state, executing the step of detecting the first position coordinates of the icon corresponding to motion sensing in the current interface.

6. An electronic device for controlling an operation component based on a gesture, comprising:
at least one processors; and
a memory communicably connected with the at least one processor for storing instructions executable by the at least one processor, wherein execution of the instructions by the at least one processor causes the at least one processor to:
detect first position coordinates of an icon corresponding to motion sensing in a current interface;
when spatial gesture information of a human body gesture for triggering an operation component in the current interface is detected, analyze the spatial gesture information to determine the operation component corresponding to the spatial gesture information and second position coordinates of the operation component in the current interface;
when the first position coordinates have an intersection with the second position coordinates, set the icon corresponding to motion sensing to a transparent overlay state.

7. The electronic device according to claim 6, wherein the processor is further configured to:
monitor in real time a moving trajectory of the icon corresponding to motion sensing in the current interface;
determine corresponding position coordinates of the icon corresponding to motion sensing in the moving trajectory at each moment.

8. The electronic device according to claim 6, wherein the processor is further configured to:
parse the spatial gesture information to obtain azimuth information, posture information and position information corresponding to the current human body gesture;
determine a trigger event corresponding to the spatial gesture information according to the azimuth information and the posture information;
determine an operation component corresponding to the trigger event and the second position coordinates of the operation component in the current interface according to the position information.

9. The electronic device according to claim 8, wherein the processor is specifically configured to judge whether the posture information is composed of two postures of push-forward and pull-backward, and when the posture information is composed of the two postures of push-forward and pull-backward, determine the trigger event corresponding to the spatial gesture information as a click event.

10. The electronic device according to claim 6, wherein the processor is further configured to detect attribute information of the icon corresponding to motion sensing before detecting the first position coordinates of the icon corresponding to motion sensing in the current interface, and when the icon corresponding to motion sensing is in a non-overlay state, execute the operation of detecting the first position coordinates of the icon corresponding to motion sensing in the current interface.

11. A non-transitory computer-readable storage medium storing executable instructions that, when executed by at least one electronic device, cause the at least one electronic device to:
detect first position coordinates of an icon corresponding to motion sensing in a current interface;
when spatial gesture information of a human body gesture for triggering an operation component in the current interface is detected, analyze the spatial gesture information to determine the operation component corresponding to the spatial gesture information and second position coordinates of the operation component in the current interface;
when the first position coordinates have an intersection with the second position coordinates, set the icon corresponding to motion sensing to a transparent overlay state.

12. (canceled)

13. The method according to claim 2, before detecting the first position coordinates of the icon corresponding to motion sensing in the current interface, further comprising:
detecting attribute information of the icon corresponding to motion sensing;
when the icon corresponding to motion sensing is in a non-overlay state, executing the step of detecting the first position coordinates of the icon corresponding to motion sensing in the current interface.

14. The method according to claim 3, before detecting the first position coordinates of the icon corresponding to motion sensing in the current interface, further comprising:
detecting attribute information of the icon corresponding to motion sensing;
when the icon corresponding to motion sensing is in a non-overlay state, executing the step of detecting the first position coordinates of the icon corresponding to motion sensing in the current interface.

15. The method according to claim 4, before detecting the first position coordinates of the icon corresponding to motion sensing in the current interface, further comprising:
detecting attribute information of the icon corresponding to motion sensing;
when the icon corresponding to motion sensing is in a non-overlay state, executing the step of detecting the first position coordinates of the icon corresponding to motion sensing in the current interface.

16. The method according to claim 2, wherein the step of analyzing the spatial gesture information to determine the operation component corresponding to the spatial gesture information and the second position coordinates of the operation component in the current interface specifically comprises:
parsing the spatial gesture information to obtain azimuth information, posture information and position information corresponding to the current human body gesture;
determining a trigger event corresponding to the spatial gesture information according to the azimuth information and the posture information;
determining an operation component corresponding to the trigger event and the second position coordinates of the operation component in the current interface according to the position information.

17. The method according to claim 16, wherein the step of determining the trigger event corresponding to the spatial gesture information according to the posture information comprises:
judging whether the posture information is composed of two postures of push-forward and pull-backward;
when the posture information is composed of the two postures of push-forward and pull-backward, determining the trigger event corresponding to the spatial gesture information as a click event.

18. The method according to claim 17, before detecting the first position coordinates of the icon corresponding to motion sensing in the current interface, further comprising:
detecting attribute information of the icon corresponding to motion sensing;
when the icon corresponding to motion sensing is in a non-overlay state, executing the step of detecting the first position coordinates of the icon corresponding to motion sensing in the current interface.

19. The electronic device according to claim 7, wherein the processor is further configured to:
parse the spatial gesture information to obtain azimuth information, posture information and position information corresponding to the current human body gesture;
determine a trigger event corresponding to the spatial gesture information according to the azimuth information and the posture information;
determine an operation component corresponding to the trigger event and the second position coordinates of the operation component in the current interface according to the position information.

20. The electronic device according to claim 19, wherein the processor is specifically configured to judge whether the posture information is composed of two postures of push-forward and pull-backward, and when the posture information is composed of the two postures of push-forward and pull-backward, determine the trigger event corresponding to the spatial gesture information as a click event.

21. The electronic device according to claim 20, wherein the processor is further configured to detect attribute information of the icon corresponding to motion sensing before detecting the first position coordinates of the icon corresponding to motion sensing in the current interface, and when the icon corresponding to motion sensing is in a non-overlay state, execute the operation of detecting the first position coordinates of the icon corresponding to motion sensing in the current interface.
